(19) United States
(12) Patent Application Publication
(10) Pub. No.: US 2025/0002756 A1
(43) Pub. Date: Jan. 2, 2025

(54) POLISHING COMPOSITION AND POLISHING METHOD

(71) Applicant: FUJIMI INCORPORATED, Aichi (JP)

(72) Inventors: Shota Suzuki, Aichi (JP); Tatsuhiko Hirano, Aichi (JP); Shogo Tsubota, Aichi (JP); Masaaki Ito, Aichi (JP); Yusuke Kawasaki, Aichi (JP); Keiji Ashitaka, Aichi (JP)

(73) Assignee: FUJIMI INCORPORATED, Aichi (JP)

(21) Appl. No.: 18/756,412

(22) Filed: Jun. 27, 2024

(30) Foreign Application Priority Data
Jun. 30, 2023 (JP) 2023-108194

(51) Int. Cl. C09G 1/02

(52) U.S. Cl. CPC C09G 1/02

(57) ABSTRACT

An object of the present invention is to provide a polishing composition and a polishing method, with which SiN can be selectively polished at a high polishing removal rate as compared with SiO₂.

The polishing composition contains colloidal silica in which an organic acid is fixed on a surface and a pH adjusting agent, in which an average aspect ratio of the colloidal silica in which the organic acid is fixed on the surface is 1.38 or more.

### TECHNICAL FIELD

The present invention relates to a polishing composition and a polishing method.

### BACKGROUND ART

In a case of manufacturing a semiconductor device, a so-called chemical mechanical polishing (CMP) art of polishing and planarizing a surface of a semiconductor substrate has been used. The CMP is a planarization method of a surface of objects to be polished (targets to be polished) such as a semiconductor substrate using a polishing composition (slurry) containing abrasives such as silica, alumina, and ceria, an anticorrosive agent, a surfactant, and the like.

The semiconductor substrate to be polished is composed of various materials such as silicon, polysilicon (polycrystalline silicon), an silicon oxide film (SiO₂ film), a silicon nitride film (SiN film), and a wiring line, plug, or the like made of a metal or the like. Therefore, there is a demand for selective polishing of only a specific material, or a problem such as dishing in which a central portion of the substrate is recessed in a dish shape due to excessive abrasion of a certain material as compared with other materials.

Since the silicon nitride film has poor chemical reactivity and is likely to have a lower polishing removal rate than other materials, particularly, in a case where the semiconductor substrate is polished by the CMP, a polishing composition capable of polishing the SiN film at a higher polishing removal rate than the SiO₂ film is desired.

### CITATION LIST

### Patent Literature

PTL 1: JP 2021-127442 A

### SUMMARY

### Technical Problem

In order to polish the SiN film at a high polishing removal rate as compared with other materials, compositions to which an additive is added have been variously studied, but a polishing composition which is not dependent on the additive and is based on a shape of the abrasives itself has not been studied.

The present invention has been made in view of such circumstances, and an object of the present invention is to provide a polishing composition and a polishing method, with which an SiN film can be polished at a high polishing removal rate.

### Solution to Problem

The present inventors have intensively studied in order to solve the above-described problems. As a result, it has been found that the above-described objects are achieved by a polishing composition which contains colloidal silica in which an organic acid is fixed on a surface and a pH adjusting agent, in which an average aspect ratio of the colloidal silica is 1.38 or more.

### Advantageous Effects of Invention

According to the present invention, there are provided a polishing composition and a polishing method, with which an SiN film can be polished at a high polishing removal rate.

### DESCRIPTION OF EMBODIMENTS

Embodiments of the present invention will be described in detail. The following embodiment shows an example of the present invention, but the present invention is not limited to the present embodiment. In addition, in the present specification, “X to Y” indicating a range means “X or more and Y or less”, and unless otherwise specified, operation, measurement, and the like of physical properties are measured under the conditions of a room temperature (20° C. to 25° C.) and a relative humidity of 40% to 50% RH.

One embodiment of the present invention is a polishing composition containing colloidal silica in which an organic acid is fixed on a surface, and a pH adjusting agent, in which an average aspect ratio of the colloidal silica is 1.38 or more.

In general, the polishing composition polishes objects to be polished by a physical action due to friction on a surface of a substrate, a chemical action due to a component other than abrasives on the surface of the substrate, and a combination of these actions. As a result, the form and type of the abrasives greatly affect a polishing removal rate.

The polishing composition according to the present embodiment contains the colloidal silica in which an organic acid is fixed on a surface, in which the average aspect ratio 1.38 or more. The fact that the average aspect ratio is 1.38 or more means that the colloidal silica consists of particles having an irregular shape. Since the colloidal silica consists of particles having an irregular shape, rolling on a polished surface is suppressed, and the colloidal silica remains on the polished surface, so that mechanical force can be sufficiently applied, and thus the polishing can be suitably performed.

The polishing method according to the present embodiment is a method of polishing objects to be polished, containing SiO₂ and SiN, using the above-described polishing composition according to the present embodiment. In a case where objects to be polished, containing SiO₂ and SiN, are polished using the above-described polishing composition according to the present embodiment, a polishing removal rate of SiN can be selectively increased with respect to SiO₂.

### <Polishing Composition>

(Colloidal Silica in which Organic Acid is Fixed on Surface)

The polishing composition according to the present invention contains, as abrasives, colloidal silica in which an organic acid is fixed on a surface. The “colloidal silica in which an organic acid is fixed on a surface” is silica in which an organic acid is chemically bonded to the surface, which is used as abrasives.

In the colloidal silica in which the organic acid is fixed on the surface, examples of a method for producing the colloidal silica before fixing the organic acid include a sodium silicate method and a sol-gel method. The colloidal silica may be colloidal silica produced by any production method, but from the viewpoint of reducing metal impurities, colloidal silica produced by a sol-gel method is preferable. The colloidal silica produced by the sol-gel method is preferable because it has a small content of corrosive ions such as metal impurities and chloride ions, which have a property of diffusing in a semiconductor. The production of the colloidal silica by the sol-gel method can be performed by a conventionally known method. Specifically, the colloidal silica can be obtained by carrying out a hydrolysis-condensation reaction using a hydrolyzable silicon compound (for example, alkoxysilane or derivatives thereof) as a raw material.

In the colloidal silica in which the organic acid is fixed on the surface, examples of the organic acid used for fixing to the surface include a sulfonic acid, a carboxylic acid, and a phosphoric acid. Among these, a sulfonic acid or a carboxylic acid is preferable, and a sulfonic acid is more preferable from the reason that a negative charge is likely to be generated. An acidic group derived from the above-described organic acid (for example, a sulfo group, a carboxyl group, a phosphoric acid group, and the like) is covalently bonded to the surface of the colloidal silica (in some cases, through a linker structure).

The colloidal silica in which the organic acid is fixed on the surface may be used as a synthetic product or a commercially available product. In addition, the colloidal silica in which the organic acid is fixed on the surface may be used alone, or two or more types thereof may be mixed and used.

A method for introducing the organic acid onto the surface of the colloidal silica is not particularly limited, and examples thereof include a method of introducing, onto the surface of the colloidal silica, the organic acid in a state of a mercapto group, an alkyl group, or the like, and then oxidizing the organic acid to a sulfonic acid or a carboxylic acid. In addition, examples thereof include a method in which the acidic group derived from the organic acid is introduced onto the surface of the colloidal silica in a state of being bonded to a protective group, and then the protective group is eliminated. In addition, it is preferable that the compound used in the case of introducing the organic acid onto the surface of the colloidal silica has at least one functional group which can become an organic acid group, and further includes a functional group used for bonding to the hydroxyl group on the surface of the colloidal silica, a functional group to be introduced for controlling hydrophobicity and hydrophilicity, a functional group to be introduced for controlling steric bulkiness, and the like.

As a specific synthesis method, in a case where the sulfonic acid which is one type of the organic acid is to be fixed on the surface of the colloidal silica, the fixing can be performed, for example, by a method described in “Sulfonic acid-functionalized silica through quantitative oxidation of thiol groups”, Chem. Commun. 246-247 (2003). Specifically, the colloidal silica in which the sulfonic acid is fixed on the surface can be obtained by coupling a silane coupling agent having a thiol group, such as 3-mercaptopropyltrimethoxysilane, to the colloidal silica and then oxidizing the thiol group with hydrogen peroxide.

Alternatively, in a case where the carboxylic acid is to be fixed on the surface of the colloidal silica, for example, the fixing can be performed by a method described in “Novel Silane Coupling Agents Containing a Photolabile 2-Nitrobenzyl Ester for Introduction of a Carboxy Group on the Surface of Silica Gel”, Chemistry Letters, 3, 228-229 (2000). Specifically, the colloidal silica in which the carboxylic acid is fixed on the surface can be obtained by coupling a silane coupling agent containing a photoreactive 2-nitrobenzyl ester to the colloidal silica and then irradiating the colloidal silica with light.

The average aspect ratio of the colloidal silica in the polishing composition, in which the organic acid is fixed on the surface, is 1.38 or more, and is more preferably 1.40 or more. In such a range, the rolling on the polished surface is suppressed, and the objects to be polished can be selectively polished at a high speed. In a case where the average aspect ratio is less than 1.38, the shape of the colloidal silica is nearly a sphere, and the ability to polish the objects to be polished tends to decrease. In addition, the upper limit of the average aspect ratio is not particularly limited, but is preferably 3.0 or less, more preferably 2.5 or less, and still more preferably 2.0 or less. In such a range, the polishing removal rate can be further improved. The average aspect ratio is an average of values obtained by taking the smallest rectangle circumscribed about an image of colloidal silica particles by a scanning electron microscope and dividing a length of a long side of the rectangle by a length of a short side of the rectangle, and it can be obtained by general image analysis software.

Specifically, the aspect ratio can be calculated by selecting 150 or more silica particles from an image measured with a scanning electron microscope (SEM) (product name: SU8000, manufactured by Hitachi High-Tech Corporation), measuring a major axis and a minor axis of the silica particles, and calculating the aspect ratio by an expression of “major axis/minor axis”. The measurement and calculation methods of the aspect ratio of the abrasives are described in detail in Examples.

The aspect ratio of the colloidal silica particles in which the organic acid is fixed on the surface can be appropriately controlled by controlling conditions during the reaction of synthesizing the colloidal silica, particularly, the amount of an alkali catalyst used during the synthesis. For example, by reducing a content of the alkali catalyst, the average aspect ratio can be increased. In addition, by increasing the content of the alkali catalyst, the average aspect ratio can be reduced.

In the present invention, the shape of the colloidal silica in which the organic acid is fixed on the surface is preferably a non-spherical shape. Specific examples of the non-spherical shape include various shapes such as a polygonal prism shape such as a triangular prism or a tetragonal prism, a cylindrical shape, a straw bag shape in which a central part of a cylinder is inflated compared to end parts, a doughnut shape in which a central part of a cylinder is perforated through, a plate shape, a so-called cocoon-like shape having a constriction in the middle part, a so-called associated type spherical shape in which a plurality of particles are integrated, a so-called konpeito shape having a plurality of bumps on the surface, and a rugby ball shape; but there are no particular limitations.

In a particle size distribution of the colloidal silica particles in which the organic acid is fixed on the surface, which is obtained by SEM, a number distribution rate (D90-D10)/D50 that is a ratio of a value, which is obtained by subtracting, from a particle diameter (D90) when a cumulative number of particles from a fine particle side reaches 90% of the total number of particles, a particle diameter (D10) when reaching 10% of the total number of particles, to a particle diameter (D50) when reaching 50% of the total number of particles is preferably 70% or more, more preferably 85% or more, still more preferably 90% or more, and particularly preferably 100% or more. In addition, in the particle size distribution of the colloidal silica particles in which the organic acid is fixed on the surface, which is obtained by SEM, the number distribution rate (D90-D10)/D50 is preferably 105% or less. In such a range, the objects to be polished can be selectively polished at a high polishing removal rate while suppressing surface defects. In a case where the number distribution rate is low, the rolling of the particles is suppressed because the particles are too densely adhered to the SiN, so that the polishing removal rate of the SiN is suppressed. In addition, in a case where the number distribution rate is too high, the polishing removal rate of the SiO₂ is increased, so that the SiN cannot be selectively polished in any case.

An average primary particle diameter of the colloidal silica in the polishing composition, in which the organic acid is fixed on the surface, is not particularly limited, and can be appropriately selected from, for example, a range of approximately 5 nm to 100 nm. From the viewpoint of improving protrusion removal property, the average primary particle diameter is preferably 5 nm or more, more preferably 7 nm or more, and still more preferably 10 nm or more. In addition, from the viewpoint of preventing occurrence of scratches, it is advantageous that the average primary particle diameter is usually 100 nm or less, preferably 80 nm or less, more preferably 50 nm or less, and still more preferably 30 nm. The value of the average primary particle diameter of the colloidal silica in which the organic acid is fixed on the surface can be calculated based on, for example, a specific surface area of the colloidal silica in which the organic acid is fixed on the surface, which is measured by a BET method. The average primary particle diameter of the silica particles can be controlled by conditions during the reaction of synthesizing the colloidal silica, particularly, a reaction temperature (that is, a liquid temperature during the reaction). By increasing the reaction temperature, the average primary particle diameter can be reduced. In addition, by lowering the reaction temperature, the average primary particle diameter can be increased.

In addition, an average secondary particle diameter of the colloidal silica in the polishing composition, in which the organic acid is fixed on the surface, is not particularly limited, and can be appropriately selected from, for example, a range of appropriately 10 nm to 200 nm. The average secondary particle diameter of the colloidal silica in which the organic acid is fixed on the surface is preferably 10 nm or more, more preferably 15 nm or more, still more preferably 20 nm or more, even more preferably 25 nm or more, and particularly preferably 30 nm or more. In addition, the average secondary particle diameter of the colloidal silica in which the organic acid is fixed on the surface is preferably 200 nm or less, more preferably 180 nm or less, still more preferably 150 nm or less, and particularly preferably 100 nm or less. The value of the average secondary particle diameter of the colloidal silica in which the organic acid is fixed on the surface can be calculated based on, for example, a measurement by a light scattering method using laser light.

The number distribution rate ((D90-D10)/D50) of the colloidal silica particles in which the organic acid is fixed on the surface can be appropriately controlled by selecting the production method such as the above-described aspect ratio and the above-described primary particle diameter.

A concentration (content) of the abrasives is not particularly limited, but is preferably 0.1% by weight or more, more preferably 0.38 by weight or more, still more preferably 0.5% by weight or more, and particularly preferably 0.8% by weight or more with respect to the total weight of the polishing composition. In addition, the upper limit of the concentration (content) of the abrasives is preferably 20% by weight or less, more preferably 15% by weight or less, still more preferably 10% by weight or less, and particularly preferably 5% by weight or less with respect to the total weight of the polishing composition. That is, the concentration (content) of the abrasives is preferably 0.1% by weight or more and 20% by weight or less, more preferably 0.3% by weight or more and 15% by weight or less, still more preferably 0.5% by weight or more and 10% by weight or less, and particularly preferably 0.8% by weight or more and 5% by weight or less with respect to the total weight of the polishing composition. In such a range, the polishing removal rate can be improved while suppressing cost. In a case where the polishing composition contains two or more types of the abrasives, the concentration (content) of the abrasives means the total amount thereof.

### (pH Adjusting Agent)

From the viewpoint of maintaining a high polishing removal rate of SiN, a pH value of the polishing composition according to the present embodiment is less than 7, preferably 6 or less, more preferably 4 or less, still more preferably 3 or less, and most preferably 2.5 or less. In addition, from the viewpoint of safety, the pH value of the polishing composition is preferably 1 or more, and more preferably 2 or more.

The pH value of the polishing composition can be adjusted by adding a pH adjusting agent. The pH adjusting agent used may be an acid or a base, but is preferably an acid or a salt thereof.

The acid is not particularly limited, and may be an inorganic acid or an organic acid. Specific examples of the inorganic acid include phosphoric acid (orthophosphoric acid), nitric acid, sulfuric acid, hydrochloric acid, boric acid, sulfamic acid, phosphinic acid, phosphonic acid, pyrophosphoric acid, tripolyphosphoric acid, tetrapolyphosphoric acid, hexametaphosphoric acid, carbonic acid, hydrofluoric acid, sulfurous acid, thiosulfuric acid, chloric acid, perchloric acid, chlorous acid, hydroiodic acid, periodic acid, iodic acid, hydrobromic acid, perbromic acid, bromic acid, chromic acid, and nitrous acid.

Specific examples of the organic acid include organic carboxylic acids such as citric acid, maleic acid, malic acid, glycolic acid, succinic acid, itaconic acid, malonic acid, iminodiacetic acid, gluconic acid, lactic acid, mandelic acid, tartaric acid, formic acid, acetic acid, propionic acid, butyric acid, adipic acid, oxalic acid, valeric acid, enanthic acid, caproic acid, caprylic acid, pelargonic acid, capric acid, lauric acid, myristic acid, palmitic acid, margaric acid, stearic acid, cyclohexanecarboxylic acid, phenylacetic acid, benzoic acid, crotonic acid, oleic acid, linoleic acid, linolenic acid, ricinoleic acid, methacrylic acid, glutaric acid, fumaric acid, phthalic acid, isophthalic acid, terephthalic acid, tartronic acid, glyceric acid, hydroxybutyric acid, hydroxyacetic acid, hydroxybenzoic acid, salicylic acid, isocitric acid, methylenesuccinic acid, gallic acid, ascorbic acid, nitroacetic acid, oxaloacetic acid, chloroacetic acid, dichloroacetic acid, and trichloroacetic acid; amino acids such as glycine, alanine, glutamic acid, aspartic acid, valine, leucine, isoleucine, serine, threonine, cysteine, methionine, phenylalanine, tryptophan, tyrosine, proline, cystine, glutamine, asparagine, lysine, and arginine; nicotinic acid; picric acid; picolinic acid; phytic acid; organic phosphonic acids such as 1-hydroxyethylidene-1,1-diphosphonic acid, aminotri(methylenephosphonic acid), ethylenediaminetetra(methylenephosphonic acid), diethylenetriaminepenta(methylenephosphonic acid), ethane-1,1-diphosphonic acid, ethane-1,1,2-triphosphonic acid, ethane-1-hydroxy-1,1-diphosphonic acid, ethanehydroxy-1,1,2-triphosphonic acid, ethane-1,2-dicarboxy-1,2-diphosphonic acid, methanhydroxyphosphonic acid, 2-phosphonobutane-1,2-dicarboxylic acid, 1-phosphonobutane-2,3,4-tricarboxylic acid, α-methylphosphonosuccinic acid, and aminopoly(methylenephosphonic acid); and organic sulfonic acids such as methanesulfonic acid, ethanesulfonic acid, aminoethanesulfonic acid, benzenesulfonic acid, p-toluenesulfonic acid, 2-naphthalenesulfonic acid, sulfosuccinic acid, 10-camphorsulfonic acid, isethionic acid, and taurine.

In addition, instead of the above-described acid or in combination with the above-described acid, a salt of the above-described acid, such as an ammonium salt and an alkali metal salt, may be used.

The polishing composition according to the present embodiment may or may not contain a base as the pH adjusting agent. Specific examples of the base include hydroxides of alkali metals, such as potassium hydroxide, ammonia, quaternary ammonium salts such as tetramethylammonium and tetraethylammonium, and amines such as ethylenediamine and piperazine.

These pH adjusting agents can be used alone or in combination of two or more types thereof.

The pH of the polishing composition can be measured by, for example, a pH meter.

### (Dispersion Medium)

The polishing composition according to the embodiment of the present invention contains a liquid medium. The liquid medium functions as a dispersion medium or a solvent for dispersing or dissolving each component (the colloidal silica in which the organic acid is fixed on the surface and the additive such as the pH adjusting agent) of the polishing composition. Examples of the liquid medium include water and an organic solvent. One type can be used alone, or two or more types can be mixed and used, but the liquid medium preferably contains water. However, from the viewpoint of preventing the effect of each component from being inhibited, it is preferable to use water which contains as little impurities as possible. Specifically, pure water, ultrapure water, or distilled water, from which impurity ions have been removed with an ion exchange resin and contaminants have been removed through a filter, is preferable.

### (Water-Soluble Polymer)

The polishing composition according to the embodiment of the present invention may or may not contain a water-soluble polymer. Specific examples of the water-soluble polymer include celluloses such as methylcellulose, methylhydroxyethylcellulose, methylhydroxypropylcellulose, hydroxyethylcellulose, hydroxypropylcellulose, carboxymethylcellulose, carboxyethylcellulose, and carboxymethylhydroxyethylcellulose; polysaccharides such as chitosan; polyalkylene glycols such as polyethylene glycol; polyethyleneimine; poly-N-vinylpyrrolidone; polyvinyl alcohol; polyacrylic acid (or a salt thereof); polyacrylamide; and polyethylene oxide. Among these, polyethylene glycol is preferable because a selectivity of the polishing removal rate of the SiN film to the polishing removal rate of the SiO₂ film can be improved.

### (Anticorrosive Agent)

The polishing composition according to the present embodiment may or may not contain an anticorrosive agent. The anticorrosive agent has an action of suppressing corrosion of the surface of the objects to be polished. Specific examples of the anticorrosive agent include amines, pyridines, tetraphenylphosphonium salts, benzotriazoles, triazoles, tetrazoles, and benzoic acid.

### (Preservative and Antimicrobial Agent)

The polishing composition according to the present embodiment may or may not contain a preservative or an antimicrobial agent. Specific examples of the preservative and the antimicrobial agent include isothiazoline-based preservatives such as 2-methyl-4-isothiazolin-3-one and 5-chloro-2-methyl-4-isothiazolin-3-one, paraoxybenzoic acid esters, and phenoxyethanol.

### (Oxidant)

The polishing composition according to the present embodiment may or may not contain an oxidant. The oxidant has an action of oxidizing the surface of the objects to be polished, and in a case where the oxidant is added to the polishing composition, there is an effect of improving the polishing removal rate by the polishing composition.

Specific examples of the oxidant include peroxides such as hydrogen peroxide, peracetic acid, percarbonate, urea peroxide, perchloric acid, and persulfate (for example, sodium persulfate, potassium persulfate, and ammonium persulfate).

### (Other Components)

The polishing composition according to the embodiment of the present invention may or may not further contain a known component used in the field of the polishing composition. The other components are not particularly limited, and examples thereof include a polishing removal accelerator, a surfactant, and an electrical conductivity adjusting agent.

### (Objects to be Polished)

With the polishing composition according to the present embodiment, it is possible to selectively set the polishing removal rate of the silicon nitride film (SiN film) to be high as compared with the silicon oxide film (SiO₂ film). Therefore, it is preferable that the objects to be polished includes the SiO₂ film and the SiN film. However, the type of the objects to be polished is not limited to the SiO₂ film and the SiN film, and may be a silicon substance, a silicon compound other than the SiO₂ film and the SiN film, a metal, or the like. Examples of the silicon substance include single crystal silicon, polysilicon, and amorphous silicon. In addition, examples of the silicon compound include silicon dioxide and silicon carbide. The silicon dioxide may be a film formed of tetraethoxysilane ((Si(OC₂H₅)₄)) (hereinafter, a TEOS film).

### (Polishing Removal Rate)

As described above, the polishing composition according to the embodiment of the present invention can selectively polish SiN with respect to SiO₂ at a high polishing removal rate. In the present invention, the polishing removal rate of SiN is preferably 180 Å/min or more, more preferably 200 Å/min or more, and still more preferably 250 Å/min or more. In addition, the polishing removal rate of SiO₂ is preferably 40 Å/min or less, more preferably 45 Å/min or less, and still more preferably 30 Å/min or less.

### (Selectivity)

In the present invention, the selectivity of the polishing removal rate of SiN to the polishing removal rate of SiO₂ is preferably 7 or more, more preferably 8 or more, and still more preferably 10 or more. In addition, the selectivity of the polishing removal rate of SiN to the polishing removal rate of SiO₂ is preferably 30 or less, more preferably 25 or less, and still more preferably 20 or less. In a case where the selectivity is outside the above-described range, a surface state of the objects to be polished after the polishing finally obtained may be deteriorated.

### <Polishing Method>

The present invention provides a polishing method of polishing objects to be polished using the polishing composition according to the embodiment of the present invention.

### (Configuration of Polishing Machine)

A configuration of a polishing machine is not particularly limited, but for example, it is possible to use a common polishing machine having a holder for holding a substrate or the like having objects to be polished, a driving unit such as a motor capable of changing the rotation rate, and a polishing platen to which a polishing pad (polishing cloth) can be attached. As the polishing pad, it is possible to use nonwoven fabric, polyurethane, a porous fluororesin, and the like, which are common, without particular limitation. As the polishing pad, it is possible to use a polishing pad which has been subjected to groove processing to accumulate the polishing composition in a liquid state.

### (Polishing Condition)

The polishing conditions are not particularly limited, but for example, the rotation rate of the polishing platen is preferably 10 rpm (0.17 s⁻¹) or more and 500 rpm (8.3 s⁻¹) or less. The pressure (polishing pressure) applied to the substrate having the objects to be polished is preferably 0.5 psi (3.4 kPa) or more and 10 psi (68.9 kPa) or less. In general, as the load is increased, frictional force due to the abrasives is increased and mechanical processing power is improved, so that the polishing removal rate is increased. In such a range, a higher polishing removal rate is exhibited, and it is possible to further suppress breakage of the substrate due to the load and occurrence of defects such as scratches on the surface. A supply method of the polishing composition to the polishing pad is also not particularly limited, and a method of continuously supplying by a pump or the like is employed. Although the supply amount is not limited, the surface of the polishing pad is preferably always covered with the polishing composition of one aspect of the present invention.

The polishing composition according to the embodiment of the present invention may be a one-liquid type or a multi-liquid type including a two-liquid type. In addition, the polishing composition may be prepared by diluting a liquid concentrate of the polishing composition with a diluent such as water, for example, 10-fold.

After the completion of the polishing, the substrate is cleaned with running water, for example, and water droplets adhered to the substrate are wiped off and dried by a spin dryer or the like, thereby obtaining a substrate having a layer containing a silicon-containing material, for example. As described above, the polishing composition according to the present embodiment can be used for application of polishing the substrate. A polished semiconductor substrate can be manufactured by polishing a surface of objects to be polished, such as an SiN film, provided on the semiconductor substrate (an example of the substrate) using the polishing composition according to the present embodiment. Examples of the semiconductor substrate include a silicon wafer having a layer containing a silicon substance, a silicon compound, a metal, or the like.

### <Method for Manufacturing Substrate>

The method for manufacturing a substrate according to the present embodiment includes a step of polishing a surface of the substrate using the above-described polishing composition. The polishing method in the step is as described in the section of Polishing method, for example.

### Examples

The embodiment of the present invention will be described in more detail with reference to Examples and Comparative Examples, but Examples show examples of the present invention, and the present invention is not limited to the following examples. Unless otherwise specified, “%” and “part” each mean “% by mass” and “part by mass”, respectively. In addition, in the following examples, unless otherwise specified, operations were performed under the conditions of room temperature (20° C. to 25° C.) and a relative humidity of 40% to 50% RH.

Physical properties of each polishing composition were measured by the following methods.

### (Aspect Ratio)

For the colloidal silica in which the organic acid was fixed on the surface in each polishing composition, a particle shape was observed by a scanning electron microscope SU8000 (manufactured by Hitachi High-Tech Corporation). An aspect ratio (average aspect ratio) of the captured SEM image was calculated by image analysis expression particle size distribution measurement software Mac-View Ver. 4 (manufactured by Mountech Co., Ltd.).

The aspect ratio was obtained by capturing an SEM image of 150 or more colloidal silica particles by SEM and analyzing the image. The average aspect ratio was obtained by obtaining a minor axis and a major axis of a circumscribed quadrangle having a minimum area for each individual particle, calculating an (each) aspect ratio of each particle from the following expression, and averaging the aspect ratios. The colloidal silica in which the organic acid was fixed on the surface, which was used for calculating the average aspect ratio, was a target of all the particles in the captured SEM image. That is, the aspect ratio was obtained according to the following expression.

Aspect ratio=(Major axis of circumscribed quadrangle having minimum area)/(Minor axis of circumscribed quadrangle having minimum area)

### <Preparation of Polishing Composition>

### Example 1

Colloidal silica in which a sulfonic acid group was fixed on the surface (average aspect ratio: 1.39, number distribution rate ((D90−D10)/D50): 70.6) and nitric acid as a pH adjusting agent was added to water as a solvent, and the mixture was stirred and mixed to prepare a polishing composition (mixing temperature: approximately 25° C., mixing time: approximately 10 minutes). The pH of the polishing composition measured by a pH meter was 2.3.

### Examples 2 to 5 and Comparative Examples 1 to 7

Polishing compositions according to Examples 2 to 5 and Comparative Examples 1 to 7 were prepared in the same manner as in Example 1, except that the average aspect ratio and the number distribution rate of the colloidal silica in which the sulfonic acid group was fixed on the surface, the pH of the polishing composition, and the like were changed as shown in Table 1.

### Comparative Example 8

A polishing composition according to Comparative Example 8 was prepared in the same manner as in Example 5, except that, instead of the colloidal silica in which the sulfonic acid group was fixed on the surface, unmodified colloidal silica (average aspect ratio: 1.42, number distribution rate: 103.3) was used.

### <Polishing Test>

### (Polishing Machine and Polishing Conditions)

In Examples 1 to 5 and Comparative Examples 1 to 8, the surface of objects to be polished was polished using each of the prepared polishing compositions under the following conditions. As the objects to be polished, a silicon wafer (300 mm, blanket wafer) on which an SiO₂ film (TEOS film) having a thickness of 10,000 Å or an SiN film having a thickness of 5,000 Å had been formed on the surface was used.

Polishing machine: F-REX300E, a single surface polishing machine for 300 mm CMP manufactured by Ebara Corporation Pad: IC1000, a rigid polyurethane pad manufactured by Nitta Haas Inc.

Polishing pressure: 2.0 psi

Rotation speed of polishing platen: 93 rpm

Rotation speed of carrier: 87 rpm

Supply of polishing composition: in one-way

Supply amount of polishing composition: 300 mL/min

Polishing time: 60 seconds

### (Evaluation of Polishing Removal Rate)

The polishing removal rate was determined by a thickness measured with an optical film thickness measuring instrument (ASET-f5x, manufactured by KLA-Tencor Corporation), and dividing (Thickness before polishing)−(Thickness after polishing) by the polishing time.

The evaluation results of the polishing removal rate are shown in Table 1.

TABLE 1

| | Colloidal silica | | | | | | | | | | | |
|---|---|---|---|---|---|---|---|---|---|---|---|---|
| | | | | | Number | | | | | | | |
| | | | Average | Average | distribution | | | | | | | |
| | | | primary | secondary | rate | | pH adjusting agent | | | Polishing removal rate | | |
| | Organic | Concen- | particle | particle | (D90 − | Average | | Concen- | Physical | SiO₂ | | |
| | acid | tration | diameter | diameter | D10)/D50 | aspect | | tration | property | (TEOS) | SiN | Selec- |
| | fixed | [%] | [nm] | [nm] | [%] | ratio | Compound | [g/kg] | pH | [Å/min] | [Å/min] | tivity |
| Ex. 1 | Y | 1.0% | 13.8 | 31 | 70.58 | 1.39 | Nitric acid | 0.11 | 2.3 | 26 | 229 | 8.7 |
| Ex. 2 | Y | 1.0% | 11.3 | 28 | 89.64 | 1.48 | Nitric acid | 0.25 | 2.1 | 23 | 198 | 8.6 |
| Ex. 3 | Y | 1.0% | 11.3 | 27 | 89.64 | 1.48 | Nitric acid | 0.25 | 2.1 | 27 | 258 | 9.5 |
| Ex. 4 | Y | 1.0% | 16.7 | 44 | 92.22 | 1.40 | Nitric acid | 0.25 | 2.1 | 24 | 297 | 12.6 |
| Ex. 5 | Y | 1.0% | 26.9 | 82 | 103.31 | 1.42 | Nitric acid | 0.25 | 2.1 | 25 | 421 | 16.8 |
| Comp. Ex. 1 | Y | 1.0% | 32.1 | 59 | 108.41 | 1.23 | Nitric acid | 0.11 | 2.6 | 50 | 315 | 6.3 |
| Comp. Ex. 2 | Y | 1.0% | 13.2 | 20 | 45.98 | 1.22 | Nitric acid | 0.25 | 2.1 | 44 | 166 | 3.8 |
| Comp. Ex. 3 | Y | 1.0% | 16.1 | 27 | 66.58 | 1.36 | Nitric acid | 0.25 | 2.1 | 52 | 267 | 5.2 |
| Comp. Ex. 4 | Y | 1.0% | 16.9 | 23 | 40.78 | 1.18 | Nitric acid | 0.25 | 2.1 | 42 | 173 | 4.1 |
| Comp. Ex. 5 | Y | 1.0% | 24.4 | 35 | 34.45 | 1.15 | Nitric acid | 0.25 | 2.1 | 48 | 124 | 2.6 |
| Comp. Ex. 6 | Y | 1.0% | 89.5 | 209 | 166.14 | 1.29 | Nitric acid | 0.25 | 2.1 | 38.0 | 195.0 | 5.1 |
| Comp. Ex. 7 | Y | 1.0% | 52.0 | 104 | 60.15 | 1.16 | Nitric acid | 0.25 | 2.1 | 52.0 | 113.0 | 2.2 |
| Comp. Ex. 8 | N | 1.0% | 26.9 | 82 | 103.30 | 1.42 | Nitric acid | 0.25 | 2.1 | 41.0 | 28.0 | 0.7 |

As shown in Table 1, in a case of using the polishing compositions of Examples 1 to 5, it was found that the polishing removal rate of SiO₂ was less than 30 Å/min and the polishing removal rate of SiN was higher than the polishing removal rate of the SiO₂ film, so that, as compared with a case of using the polishing compositions of Comparative Examples 1 to 8, the polishing removal rate of SiO₂ was lower and the SiN film which was the objects to be polished could be selectively polished. In addition, in Comparative Example 8 in which the unmodified colloidal silica was used as the abrasives, it was found that the polishing removal rate of SiN was lower than the polishing removal rate of SiO₂, and the SiN film could not be selectively polished.

1. A polishing composition comprising:
colloidal silica in which an organic acid is fixed on a surface; and
a pH adjusting agent,
wherein an average aspect ratio of the colloidal silica is 1.38 or more.

2. The polishing composition according to claim 1, wherein, in a particle size distribution of the colloidal silica calculated by SEM image analysis, a ratio (D90−D10)/D50 of a difference between a particle diameter D90 when a cumulative number of particles from a fine particle side reaches 90% of a total number of particles and a particle diameter D10 when the cumulative number of particles from the fine particle side reaches 10% of the total number of particles to a particle diameter D50 when the cumulative number of particles from the fine particle side reaches 50% of the total number of particles is 70% or more and 105% or less.

3. The polishing composition according to claim 2, wherein the ratio (D90−D10)/D50 is 90% or more and 105% or less.

4. The polishing composition according to claim 1, wherein a pH is less than 7.

5. The polishing composition according to claim 4, wherein the pH is less than 4.

6. The polishing composition according to claim 1, wherein the pH adjusting agent is an acid.

7. The polishing composition according to claim 1, wherein the organic acid is a sulfonic acid.

8. The polishing composition according to claim 1, wherein, in a case of polishing objects to be polished, containing SiO₂ and SiN, the SiN has a selectively higher polishing removal rate than the SiO₂.

9. A polishing method for polishing objects to be polished, containing SiO₂ and SiN, using the polishing composition according to claim 1, wherein a polishing removal rate of the SiN is selectively higher than a polishing removal rate of the SiO₂.

10. The polishing method according to claim 9, wherein a selectivity of the polishing removal rate of the SiN to the polishing removal rate of the SiO₂ is 6.5 or more and 20 or less.

11. The polishing method according to claim 10, wherein the selectivity is 10 or more and 20 or less.

12. The polishing composition according to claim 2, wherein a pH is less than 7.

13. The polishing composition according to claim 12, wherein the pH is less than 4.

14. The polishing composition according to claim 2, wherein the pH adjusting agent is an acid.

15. The polishing composition according to claim 2, wherein the organic acid is a sulfonic acid.

16. The polishing composition according to claim 2, wherein, in a case of polishing objects to be polished, containing SiO₂ and SiN, the SiN has a selectively higher polishing removal rate than the SiO₂.

17. A polishing method for polishing objects to be polished, containing SiO₂ and SiN, using the polishing composition according to claim 2, wherein a polishing removal rate of the SiN is selectively higher than a polishing removal rate of the SiO₂.

18. The polishing method according to claim 17, wherein a selectivity of the polishing removal rate of the SiN to the polishing removal rate of the SiO₂ is 6.5 or more and 20 or less.

19. The polishing method according to claim 18, wherein the selectivity is 10 or more and 20 or less.
